(19) United States
(12) Patent Application Publication
(10) Pub. No.: US 2006/0262496 A1
(43) Pub. Date: Nov. 23, 2006

(54) Portable computer having detachable display

(76) Inventor: Seung-won Lee, Seoul (KR)

Correspondence Address: STANZIONE & KIM, LLP, 919 18TH STREET, N.W., SUITE 440, WASHINGTON, DC, 20006, US

(21) Appl. No.: 11/410,911

(22) Filed: Apr. 26, 2006

(30) Foreign Application Priority Data
May 23, 2005 (KR) 2005-43060

(51) Int. Cl. G06F 1/16

(52) U.S. Cl. 361/683

(57) ABSTRACT

A portable computer includes a computer main body, a display, a hinge part having a main body bracket coupled to the computer main body, a display bracket coupled to the display, and a hinge shaft tiltably coupled to one of the main body bracket and the display bracket, and a locking part having a separating unit which moves between a coupling position in which the locking unit connects the one of the main body bracket and the display bracket not coupled with to the hinge shaft with the hinge shaft to connect the main body bracket and the display bracket via the hinge shaft and to allow the display to tilt with respect to the computer main body, and a separating position in which the locking part separates the one of the main body bracket and the display bracket not coupled to the hinge shaft from the hinge shaft to allow the display to be separated from the computer main body. Accordingly, the display is easily separated from and coupled to the computer main body.

### CROSS-REFERENCE TO RELATED APPLICATIONS

This application claims the benefit under 35 U.S.C. § 119 of Korean Patent Application No. 2005-43060, filed on May 23, 2005, in the Korean Intellectual Property Office, the disclosure of which is incorporated herein in its entirety by reference.

### BACKGROUND OF THE INVENTION

1. Field of the Invention

The present general inventive concept relates to a portable computer, and more particularly, to a portable computer having an improved structure to couple a computer main body and a display.

2. Description of the Related Art

Conventionally, a portable computer includes a computer main body, a display receiving an image signal from the computer main body and forming an image, and a tilting hinge connecting the display and the computer main body to make the display be tiltably coupled with respect to the computer main body.

Such a conventional portable computer having the display is disclosed in Korean Patent Application No. 10-1997-40463. The conventional portable computer comprises a laptop computer main body, a Liquid Crystal Display (LCD) module forming an image, a LCD module detachable part detachably coupled with the LCD module, and a hinge part connecting the computer main body and the LCD module detachable part to allow the LCD module detachable part to tilt with respect to the computer main body.

An end side of the LCD module is provided with a first contact terminal and a coupling pin. The LCD module detachable part is formed with a second contact terminal coupled with the first contact terminal, and a plurality of grooves to couple with the coupling pin.

The plurality of grooves accommodates the coupling pin which is provided in LCD modules of various sizes.

Therefore, the conventional portable computer may selectively dispose the LCD modules of the various sizes at the computer main body.

However, the conventional portable computer cannot use the display as a monitor when the display is separated from the computer main body.

Further, in the conventional portable computer, there is a need for an improved coupling structure in which the display is easily separated from and coupled to the computer main body.

### SUMMARY OF THE INVENTION

Accordingly, the present general inventive concept provides a portable computer in which a display is easily separated from and coupled to a computer main body.

The present general inventive concept also provides a portable computer in which a display separated from a computer main body may be used as a monitor.

Additional aspects of the present general inventive concept will be set forth in part in the description which follows and, in part, will be obvious from the description, or may be learned by practice of the present general inventive concept.

The foregoing and/or other aspects of the present general inventive concept may be achieved by providing a portable computer, comprising a computer main body, a display, a hinge part having a main body bracket coupled to the computer main body, a display bracket coupled to the display, and a hinge shaft tiltably coupled to one of the main body bracket and the display bracket, and a locking part having a separating unit which moves between a coupling position in which the locking part connects the one of the main body bracket and the display bracket not coupled to the hinge shaft with the hinge shaft to connect the main body bracket and the display bracket via the hinge shaft and to allow the display to tilt with respect to the computer main body, and a separating position in which the locking part separates the one of the main body bracket and the display bracket not coupled to the hinge shaft from the hinge shaft to allow the display to be separated from the computer main body.

The locking part may comprise a locking member which moves between the coupling position and the separating position and tilts together with the hinge shaft when disposed in the coupling position, and uncouples with the hinge shaft when disposed in the separating position.

The hinge shaft may be tiltably coupled to the main body bracket, and the display bracket may comprise a locking member supporter to slidably support the locking member to allow the locking member to couple and uncouple with the hinge shaft.

The separating unit may comprise a lever provided at the locking member and to slidably operate the locking member with respect to the locking member supporter.

The locking member supporter may comprise a lever guide to guide the lever in a sliding direction of the locking member.

The hinge shaft may comprise a locking member holder to accommodate an end of the locking member to couple with the locking member and tilt together with the locking member.

The locking member, the locking member holder, and the locking member supporter may have a non-circular sectional shape.

The locking part may further comprise an elastic member to press the locking member in a direction toward the hinge shaft to control the locking member to remain coupled to the hinge shaft.

The display may comprise a connector, and the computer main body may comprise a connectivity port connectable with the connector.

The portable computer may further comprise a connecting cable to connect the connector and the connectivity port when the display is separated from the computer main body.

The portable computer may comprise a display supporting device to support the display when the display is separated from the computer main body.

The display supporting device may comprise a stand and a supporter provided at the stand to support the display.

The display may comprise a fastener, and the supporter is fastenable to the display the fastener.

The foregoing and/or other aspects of the present general inventive concept may also be achieved by providing a portable computer, comprising a computer main body comprising one or more first brackets extending from a surface thereof and a hinge shaft coupled to each of the first brackets, tiltable with respect to the computer main body, and including a first accommodating portion, and a display comprising one or more second brackets extending from a surface thereof, each of second brackets including a second accommodating portion, and a locking unit to protrude through the second accommodating portion of each of the second brackets and be inserted into the first accommodating portion of the hinge shaft coupled to each of the first brackets to attach the display to the computer main body by connecting each of the first and second brackets, and slideable within the second accommodating portion away from the first accommodating portion to detach the display from the computer main body by disconnecting each of the first and second hatches.

The foregoing and/or other aspects of the present general inventive concept may also be achieved by providing a portable computer, comprising a computer main body comprising a tilting unit tiltable with respect to a surface of the computer main body and having an accommodating portion, and a display comprising a protruding portion slideable into the accommodating portion of the tilting unit to couple the display to the computer main body such that the display is tiltable with respect to the computer main body and slideable out of the accommodating portion of the tilting unit to detach the display from the computer main body, and a connecting portion to connect the display to one of the computer main body and an external device when the display is detached from the computer main body.

The foregoing and/or other aspects of the present general inventive concept may also be achieved by providing a display device attachable to a computer main body of a portable computer, comprising a display bracket extending from a surface thereof and including a locking member supporting portion, a locking unit including a locking member slideably supported by the locking member supporting portion to slide to a first position to attach the display bracket with the computer main body of the portable computer and a second position to detach the display bracket from the computer main body of the portable computer, and a connecting unit connectable to at least one of the computer main body of the portable computer and an external device to input image signals.

The foregoing and/or other aspects of the present general inventive concept may also be achieved by providing a display device usable with a computer main body of a portable computer, comprising a body, a first connecting unit having a display bracket mounted on the body of the display device, and a hinge part connected to the display bracket and rotatably connectable to an external computer main body, and a second connecting unit formed on the body of the display device to be coupled to an external stand.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view illustrating a portable computer according to an embodiment of the present general inventive concept;

FIGS. 2 and 3 are exploded perspective views illustrating the portable computer of FIG. 1;

FIGS. 4 and 5 are a perspective views illustrating operations to detach a display of the portable computer of FIG. 1;

FIG. 6 is a perspective view illustrating a state in which the display of the portable computer of FIG. 1 is separated from a computer main body; and

FIG. 7 is a perspective view illustrating a state in which the display separated from the portable computer of FIG. 1 couples with a display supporting device.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

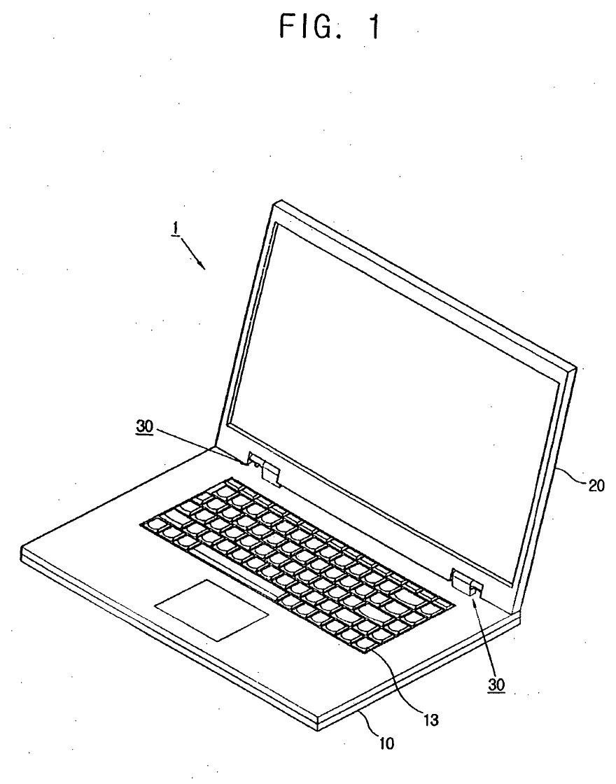

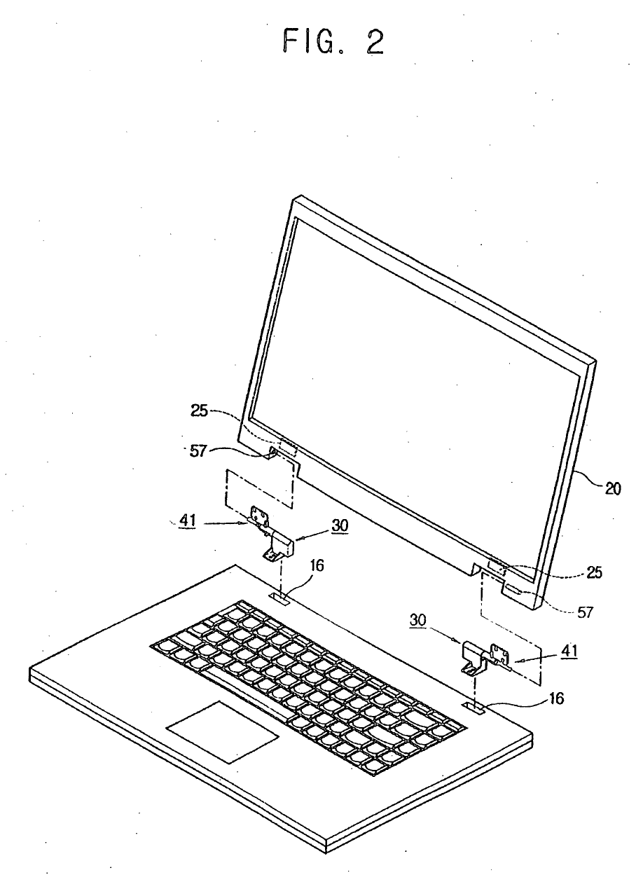

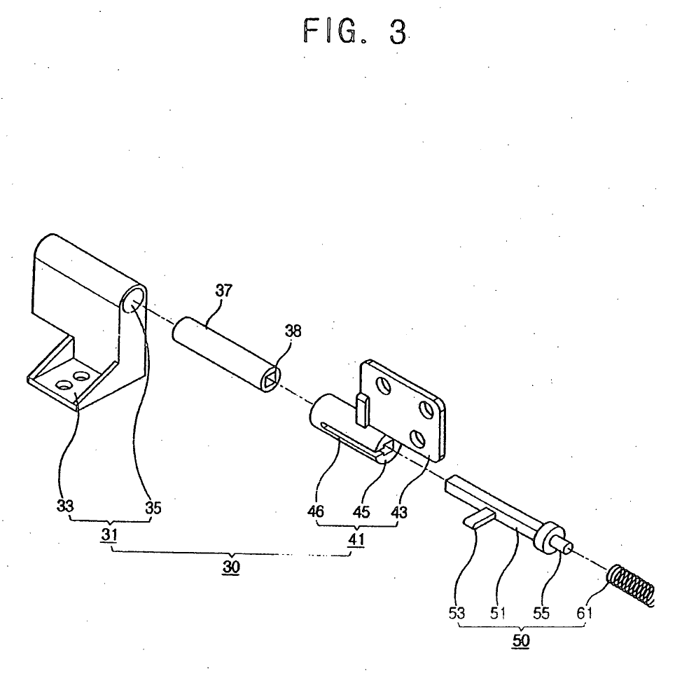

FIG. 1 is a perspective view illustrating a portable computer 1 according to an embodiment of the present general inventive concept, and FIGS. 2 and 3 are exploded perspective views illustrating the portable computer 1 of FIG. 1.

Referring to FIGS. 1-3, the portable computer 1 comprises a computer main body 10, a display 20 to form an image thereon, a hinge part 30 to tiltably couple the computer main body 10 and the display 20, and a locking part 50 coupled to the hinge part 30 to attach the display 20 to or separate the display 20 from the computer main body 10.

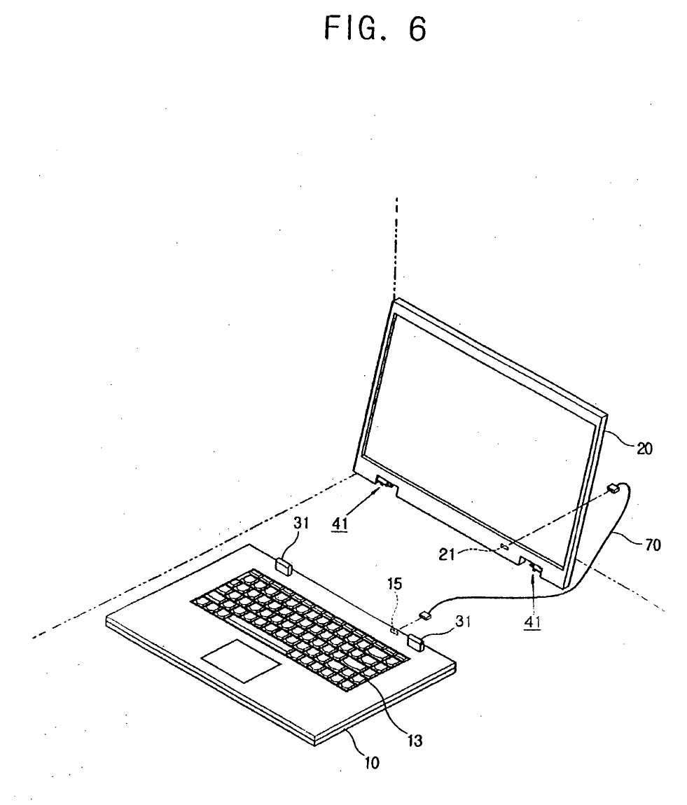

The computer main body 10 can be stably seated on a horizontal surface, such as a table or a lap of a user. The computer main body 10 may comprise a main board and a Central Processing Unit (CPU), which are disposed therein to form an image signal, etc., and a key board 13 provided thereon to input data. The computer main body 10 may be provided with a connectivity port 15 (see FIG. 6) to connect with a connector 21 (see FIG. 6), or the like, provided in the display 20. The computer main body 10 may also be provided with a first wireless communicator (not shown) to wirelessly send and receive the image signal to/from the display 20 and the like. The first wireless communicator may be disposed in the connectivity port 15 or may be combined with the connectivity port 15 as a single structure to provide a communication passage between the computer main body 10 and the display 20. The computer main body 10 may also be provided with a pair of main body bracket fasteners 16 which are coupled with a main body supporter 33 of a main body bracket 31 by a screw, etc. to support the main body bracket 31.

The connectivity port 15 (see FIG. 6) is connectable with the connector 21 (see FIG. 6) provided in the display 20 and supplies electric power and the image signal to the display 20. The connectivity port 15 can be provided at a rear surface of the computer main body 10, as illustrated in FIG. 6, but may alternatively be provided at a lateral surface or a front surface of the computer main body 10.

The display 20 receives the image signal and forms the image according to the received image signal. The display 20 is provided with a driving part (not shown) to drive the display 20 to receive the image signal and form the image. The display 20 may use an LCD panel, which is thin and light weight, to form the image. Alternatively, the display 20 may use a flat display panel, such as a Plasma Display Panel (PDP). The display 20 can be tiltably coupled to the computer main body 10 by a hinge shaft 37 of the hinge part 30. The display 20 may be provided with the connector 21 to connect with the connectivity port 15 provided in the computer main body 10 (see FIG. 6). The display 20 is provided with a second wireless communicator (not shown) to wirelessly send and receive the image signal to and from the first wireless communicator (not shown) of the computer main body 10 and the like. The second wireless communicator may be disposed in the connector 21 or may be combined with the connector 21 as a single structure to provide a communication passage between the computer main body 10 and the display 20. The display 20 is provided with a pair of display bracket fasteners 25 which are coupled with a display supporter 43 of a display bracket 41 by the screw, etc. to support the display bracket 41.

The connector 21 supplies the electric power and the image signal to the display 20. In a case in which an antenna (not shown) is disposed at the display 20, the connector 21 may transfer an antenna signal to the computer main body 10, etc. The connector 21 can be connected to the connectivity port 15 by a connecting cable 70 (see FIG. 6). The connector 21 can be provided at a rear surface of the display 20, as illustrated in FIG. 6, but may alternatively be provided at a lateral surface or a front surface of the display 20.

A pair of the hinge parts 30 can be provided between the computer main body 10 and the display 20 to allow the display 20 to tilt with respect to the computer main body 10. Each hinge part 30 comprises the main body bracket 31 coupled to the computer main body 10, the display bracket 41 coupled to the display 20, and the hinge shaft 37 tiltably or rotatably coupled to one of the main body bracket 31 and the display bracket 41.

As illustrated in FIG. 3, the main body bracket 31 may comprise the main body supporter 33 coupled to the computer main body 10 and a shaft holder 35 to accommodate the hinge shaft 37. The main body supporter 33 can be coupled to the main body bracket fastener 16 of the computer main body 10 by a screw or the like.

The shaft holder 35 can be provided at an upper side of the main body supporter 33. The shaft holder 35 can be tiltably or rotatably coupled with the hinge shaft 37 which has a predetermined rotating friction with the shaft holder 35. Accordingly, a user can pressurize the display 20 using a force stronger than the predetermined rotating friction of the hinge shaft 37 to tilt the display 20 with respect to the computer main body 10.

The hinge shaft 37 has an axis line extending in a horizontal direction (i.e., a widthwise direction of the computer main body 10), and can be inserted into the shaft holder 35 of the main body bracket 31. Alternatively, the hinge shaft 37 can be tiltably coupled to the display bracket 41 to tiltably support the display 20 with respect to the computer main body 10 in a state in which the display 20 is coupled with the computer main body 10. The hinge shaft 37 is provided with a locking member holder 38 to accommodate a first end of a locking member 51 of the locking part 50.

The locking member holder 38 can be provided with a non-circular shape corresponding to the locking member 51 so that the hinge shaft 37 tilts together with the locking member 51 with respect to the shaft holder 35 of the main body bracket 31. As illustrated in FIG. 3, the locking member holder 38 can be provided with a rectangular section. However, the locking member holder 38 is not limited to the rectangular section, and may alternatively be provided with various polygon sections, such as a triangular section, or provided with an oval section.

The display bracket 41 may comprise a display supporter 43 coupled to the display 20, and a locking member supporter 45 to slidably support the locking member 51. The display supporter 43 is coupled to the display bracket fastener 25 of the display 20 by a screw, or the like.

The locking member supporter 45 slidably accommodates the locking member 51 so that the locking member 51 can couple and uncouple with the hinge shaft 37. The locking member supporter 45 may be formed with the non-circular shape to accommodate and tilt together with the locking member 51. As illustrated in FIG. 3, the locking member supporter 45 is formed with the rectangular section corresponding to the locking member 51, however the present general inventive concept is not limited thereto. The locking member supporter 45 is provided with a lever guide 46 to guide a lever 53 provided to the locking member 51.

The lever guide 46 is formed in the locking member supporter 45 to allow the lever 53 pass through, and extends in a direction in which the locking member 51 slides to guide the lever 53.

The locking part 50 may comprise a separating unit which moves between a coupling position and a separating position. In the coupling position, the locking part 50 connects the one of the main body bracket 31 and the display bracket 41 not coupled to the hinge shaft 37 with the hinge shaft 37 to connect the display 20 with the computer main body 10 and to allow the display 20 to tilt with respect to the computer main body 10. In the separating position, the locking part 50 separates the one of the main body bracket 31 and the display bracket 41 not coupled to the hinge shaft and the hinge shaft 37 to allow the display 20 to be separated from the computer main body 10. As illustrated in FIG. 3, the locking part 50 comprises the locking member 51 which tilts together with the hinge shaft 37 when in the coupling position, and disconnects from the hinge shaft 37 when in the separating position. The locking member 50 further comprises an elastic member 61, which biases the locking member 51 in a direction of the hinge shaft 37 to hold the locking member 51 in the coupling position in which the locking member 51 is accommodated in the locking member holder 38 of the hinge shaft 37.

The locking member 51 can be provided with a long bar shape and is slidably accommodated into the locking member supporter 45 of the display bracket 41. As described above, the locking member 51 can be provided with the non-circular section shape. When the locking member 51 is in the coupling position, the first end of the locking member 51 is inserted into the locking member holder 38 of the hinge shaft 37 to tilt together with the hinge shaft 37. A second end of the locking member 51 is slidably accommodated into the locking member supporter 45 of the display bracket 41. The locking member 51 can be provided with the rectangular section as illustrated in FIG. 3, but may alternatively be provided with various shapes to be inserted into the locking member holder 38 of the hinge shaft 37. When the first end of the locking member 51 is inserted into the locking member holder 38 of the hinge shaft 37, the display 20 is tiltably coupled to the computer main body 10, and when the first end of the locking member 51 is separated from the locking member holder 38 of the hinge shaft 37, the display 20 can be separated from the computer main body 10. The locking member 51 is provided with the lever 53 as the separating unit to slide the locking member 51 within the locking member supporter 45. The second end of the locking member 51 is provided with an elastic member supporter 55 to support the elastic member 61.

The separating unit allows the user move the locking member 51 from the coupling position to the separating position. As illustrated in FIG. 3, the separating unit can be the lever 53 provided to the locking member 51. However, the separating unit is not limited to the lever 53, and can be provided in various shapes to move the locking member 51. The lever 53 is exposed through the lever guide 46 of the locking member supporter 45 to allow the user to easily slide the locking member 51. Accordingly, the user may couple the locking member 51 to the locking member holder 38 of the hinge shaft 37 and may separate the locking member 51 from the locking member holder 38 of the hinge shaft 37 using the lever 58.

The elastic member 61 biases the locking member 51 such that the first end of the locking member 51 remains coupled to the locking member holder 38 of the hinge shaft 37. The elastic member 61 can be provided as a coil spring, as illustrated in FIG. 3. Alternatively, the elastic member 61 is not limited to the coil spring, and may be provided as various other elastic members, such as a rubber material to exert an elastic force, a leaf spring, and the like. The elastic member 61 is provided between the elastic member supporter 55 of the locking member 51 and the display 20 to bias the second end side of the locking member 51 in the direction of the hinge shaft 37. The elastic member 61 is inserted into an elastic member holder 57 provided in the display 20 and biases the elastic member supporter 55 of the locking member 51.

The elastic member holder 57, as illustrated in FIG. 2, can be provided in a lower side of the display 20 to accommodate the elastic member 61. The elastic member holder 57 may accommodate the second end of the locking member 51 when the locking member 51 is in the separating position in which the locking member 51 is separated from the locking member holder 38 of the hinge shaft 37.

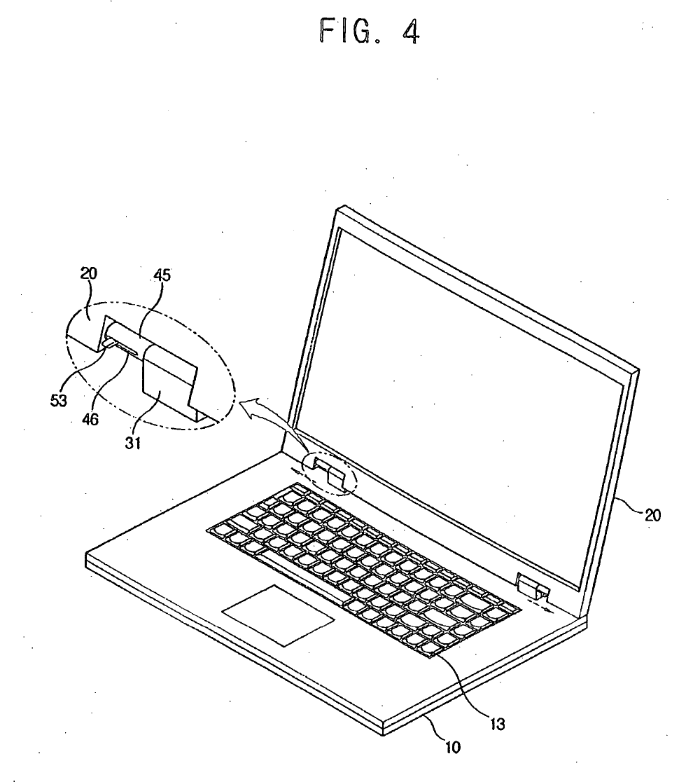

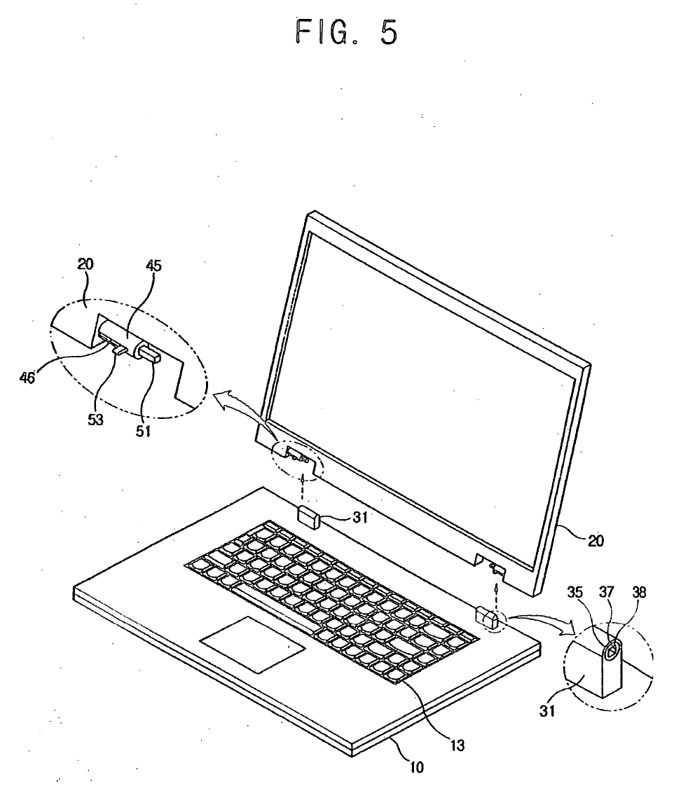

FIGS. 4 and 5 illustrate operations to detach the display 20 from the computer main body 10 of the portable computer 1. Referring to FIGS. 1-5, operations of the portable computer 1 will be described below.

As illustrated in FIGS. 1-3, the display 20 can tilt about the hinge shaft 37 in the state in which the display 20 is coupled to the computer main body 10. In this case, the first end of the locking member 51 is inserted into the locking member holder 38 of the hinge shaft 37 by the elastic force of the elastic member 61. Accordingly, the display 20 can tilt with respect to the main body bracket 31 together with the display bracket 41, the locking member 51, and the hinge shaft 37. That is, the display 20 can tilt about the hinge shaft 37 of the hinge part 30 to be folded towards the computer main body 10, or to be unfolded from the computer main body 10 to make a predetermined angle with respect to the computer main body 10. As illustrated in FIGS. 4-5, the user overcomes the elastic force of the elastic member 61 and slides the lever 53 connected to each locking member 51 away from the locking member holder 38 of each hinge shaft 37. Accordingly, the first end of the locking member 51 is separated from the locking member holder 38 of the hinge shaft 37. The user can then separate the display 20 and the display bracket 41 from the main body bracket 31. Accordingly, the user can easily separate the display 20 from the computer main body 10.

Operations to couple the display 20 and the computer main body 10 are in a reverse order of the operations to separate the display 20 and the computer main body 10, and a detail description thereof are omitted.

As described above, the user can operate the locking member 51 to couple and separate the display 20 to and from the computer main body 10.

The locking member 51 is constantly biased by the elastic member 61, thereby stably coupling the display 20 and the computer main body 10 in the state in which the display is coupled to the computer main body 10.

Further, if a defect occurs in the display 20, the user can easily separate the display 20 from the computer main body 10, and then replace the display 20 with a new or different display.

FIG. 6 is a perspective view illustrating the state in which the display 20 of the portable computer 1 is separated from the computer main body 10. As described above, the portable computer 1 may further comprise the connecting cable 70 to connect the connector 21 and the connectivity port 15 when the display 20 is separated from the computer main body 10.

A first end of the connecting cable 70 can be connected with the connector 21 provided in the display 20, and a second end of the connecting cable 70 can be connected to the connectivity port 15 provided in the computer main body 10. Therefore, when the display 20 is separated from the computer main body 10, the display 20 and computer main body 10 can be connected by the connecting cable 70, so that the display 20 may be used as a monitor, which can be disposed at various positions separate from the computer main body 10, such as a wall. In addition, the first end of the connecting cable 70 can be connected with the connector 21 of the display 20, and the second end of the connecting cable 70 can be connected with a connectivity port provided in a different computer system (not shown) other than the computer main body 10. Therefore, the display 20 can be connected to the different computer system (not shown) other than the computer main body 10 and used as the monitor of the different computer system.

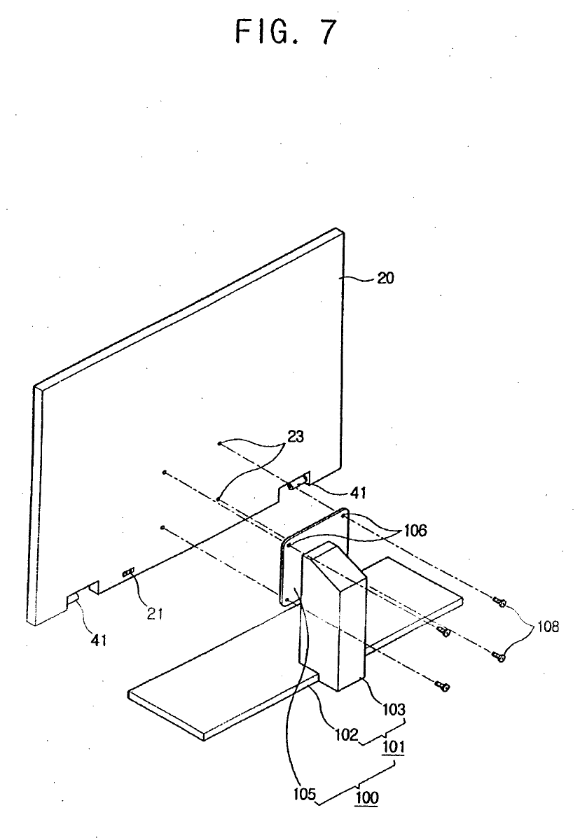

FIG. 7 is a perspective view illustrating a state in which the display 20 separated from the computer main body 10 couples with a display supporting device 100.

The display supporting device 100 may comprise a stand 101, and a supporter 105 provided at the stand 101 to couple with the display 20.

The display 20 is provided with a plurality of fasteners 23. The fasteners 23 are fastened to the supporter 105 by screws 108 or the like. The fasteners 23 may be provided by a Video Electronic Standard Association (VESA) standard. Accordingly, the display 20 may be fastened to various supporting devices which adhere to the VESA standard.

The stand 101 may comprise a base part 102 to stably sit on the predetermined horizontal surface, and a stand part 103 extending in a vertical direction from the base part 102. The stand 101 can be provided with a socket (not shown) which is connectable with the computer main body 10 or the different computer system (not shown) to send and receive the electric power and the image signal with the display 20.

The supporter 105 is coupled to the stand part 103 to support the display 20. The supporter 105 can be provided with a plurality of penetrating parts 106 to couple with the fasteners 23 of the display 20 by the screws 108.

Accordingly, the display 20 can be separated from the computer main body 10 and then easily coupled to the supporter 105.

Therefore, the user can separate the display 20 from the computer main body 10 and connect the separated display 20 to the display supporting device 100, to thereby use the separated display 20 as the monitor since the display can be connected to the computer main body 10 or the different computer system through a wire, such as the connecting cable 70, or a wireless communication unit.

As described above, the display 20 includes a first connecting unit to be rotatably connected to the computer main body 10 and a second connecting unit, such as the fasteners 23, to be connected to the stand 100. The first connecting unit may include the locking part 50 and the hinge part 30 to be tiltably connected to the main body bracket 31 of the computer main body 10.

As described above, in the portable computer 1, the hinge shaft 37 includes a first accommodating portion, such as the locking member holder 38, and the display bracket 41 includes a second accommodating portion, such as the locking member supporter 45. The locking member 51 can protrude through the first accommodating portion and be inserted into the second accommodating portion to attach the display 20 to the computer main body 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A portable computer, comprising:
a computer main body;
a display;
a hinge part having a main body bracket coupled to the computer main body, a display bracket coupled to the display, and a hinge shaft tiltably coupled to one of the main body bracket and the display bracket; and
a locking part having a separating unit which moves between a coupling position in which the locking part connects the one of the main body bracket and the display bracket not coupled to the hinge shaft with the hinge shaft to connect the main body bracket and the display bracket via the hinge shaft and to allow the display to tilt with respect to the computer main body, and a separating position in which the locking part separates the one of the main body bracket and the display bracket not coupled to the hinge shaft from the hinge shaft to allow the display to be separated from the computer main body.

2. The portable computer according to claim 1, wherein the locking part comprises a locking member which moves between the coupling position and the separating position, couples with and tilts together with the hinge shaft when disposed in the coupling position, and uncouples with the hinge shaft when disposed in the separating position.

3. The portable computer according to claim 2, wherein the hinge shaft is tiltably coupled to the main body bracket, and the display bracket comprises a locking member supporter to slidably support the locking member to allow the locking member to couple and uncouple with the hinge shaft.

4. The portable computer according to claim 3, wherein the separating unit comprises a lever provided at the locking member and to slidably operate the locking member with respect to the locking member supporter.

5. The portable computer according to claim 4, wherein the locking member supporter comprises a lever guide to guide the lever in a sliding direction of the locking member.

6. The portable computer according to claim 3, wherein the hinge shaft comprises a locking member holder to accommodate an end of the locking member to couple with the locking member and tilt together with the locking member.

7. The portable computer according to claim 6, wherein the locking member, the locking member holder, and the locking member supporter have a non-circular sectional shape.

8. The portable computer according to claim 3, wherein the locking part further comprises an elastic member to bias the locking member in a direction toward the hinge shaft to control the locking member to remain coupled to the hinge shaft.

9. The portable computer according to claim 1, wherein the display comprises a connector, and the computer main body comprises a connectivity port connectable with the connector.

10. The portable computer according to claim 9, further comprising:
a connecting cable to connect the connector and the connectivity port when the display is separated from the computer main body.

11. The portable computer according to claim 1, further comprising:
a display supporting device to support the display when the display is separated from the computer main body.

12. The portable computer according to claim 11, wherein the display supporting device comprises a stand and a supporter provided at the stand to support the display.

13. The portable computer according to claim 12, wherein the display comprises a fastener, and the supporter is fastenable to the display with the fastener.

14. A portable computer, comprising:
a computer main body comprising one or more first brackets extending from a surface thereof and a hinge shaft coupled to each of the first brackets, tiltable with respect to the computer main body, and including a first accommodating portion; and
a display comprising one or more second brackets extending from a surface thereof, each of second brackets including a second accommodating portion, and a locking unit to protrude through the second accommodating portion of each of the second brackets and be inserted into the first accommodating portion, of the hinge shaft coupled to each of the first brackets to attach the display to the computer main body by connecting each of the first and second brackets, and slideable within the second accommodating portion away from the first accommodating portion to detach the display from the computer main body by disconnecting each of the first and second brackets.

15. The portable computer according to claim 14, wherein the display further comprises an elastic member to elastically bias the locking unit toward the first accommodating portion of the hinge shaft.

16. The portable computer according to claim 15, wherein the locking unit comprises a lever to slide the locking unit away from the first accommodating portion of the hinge shaft.

17. The portable computer according to claim 14, wherein the display further comprises a connecting unit connectable to at least one of the computer main body and an external device when the display is detached from the computer main body.

18. A portable computer, comprising:
a computer main body comprising a tilting unit tiltable with respect to a surface of the computer main body and having an accommodating portion; and
a display comprising a protruding portion slideable into the accommodating portion of the tilting unit to couple the display to the computer main body such that the display is tiltable with respect to the computer main body and slideable out of the accommodating portion of the tilting unit to detach the display from the computer main body, and a connecting portion to connect the display to one of the computer main body and an external device when the display is detached from the computer main body.

19. The portable computer according to claim 17, wherein the display further comprises a fastening unit to fasten the display to a supporting stand when the display is detached from the computer main body.

20. A display device attachable to a computer main body of a portable computer, comprising:
a display bracket extending from a surface thereof and including a locking member supporting portion;
a locking unit including a locking member slideably supported by the locking member supporting portion to slide to a first position to attach the display bracket with the computer main body of the portable computer and a second position to detach the display bracket from the computer main body of the portable computer; and
a connecting unit connectable to at least one of the computer main body of the portable computer and an external device to input image signals.

21. The display device according to claim 20, further comprising:
a fastening unit fastenable to a predetermined support stand to support the display device.

22. The display device according to claim 20, wherein the locking unit further includes an elastic member to bias the locking member toward the first position and a lever to apply a force to the locking member to slide the locking member toward the second position.

23. A display device usable with a computer main body of a portable computer, comprising:
a body;
a first connecting unit having a display bracket mounted on the body of the display device, and a hinge part connected to the display bracket and rotatably connectable to an external computer main body; and
a second connecting unit formed on the body of the display device to be coupled to an external stand.
